(19) United States
(12) Patent Application Publication
(10) Pub. No.: US 2017/0120196 A1
(43) Pub. Date: May 4, 2017

(54) FILTRATION APPARATUS

(71) Applicant: SUMITOMO ELECTRIC INDUSTRIES, LTD., Osaka-shi, Osaka (JP)

(72) Inventors: Hiromu TANAKA, Osaka (JP); Hiroko MIKI, Osaka (JP); Tomoyuki YONEDA, Osaka (JP); Kiyoshi IDA, Osaka (JP); Toru MORITA, Osaka (JP)

(21) Appl. No.: 15/106,364

(22) PCT Filed: Jan. 22, 2016
(86) PCT No.: PCT/JP2016/051936

§ 371 Date: Jun. 20, 2016

(30) Foreign Application Priority Data
Jun. 8, 2015 (JP) 2015-115618

(51) Int. Cl. B01D 63/04; C02F 1/44; B01D 65/02

(52) U.S. Cl. CPC B01D 63/04; B01D 65/02; C02F 1/44; B01D 2321/185; B01D 2319/04; B01D 2313/06

(57) ABSTRACT

An object is to provide a filtration apparatus which can be reduced in size by relatively densely arranging a plurality of filtration modules and in which the efficiency of cleaning the hollow-fiber membranes can be increased. A filtration apparatus according to the present invention includes a plurality of filtration modules, each including a plurality of hollow-fiber membranes, which are arranged in parallel in a vertical direction so as to form a substantially curtain-like shape, and a pair of rod-shaped holding members that secure top and bottom ends of the hollow-fiber membranes; one or more cleaning modules that supply bubbles to the filtration modules from below; and a frame that holds the filtration modules and the one or more cleaning modules. The filtration modules are arranged in parallel and with substantially constant intervals therebetween. A plurality of guide rails that engage with the lower holding members of the filtration modules extend between opposing surfaces of a plurality of frame members that are arranged horizontally in parallel. The one or more cleaning modules preferably have bubble ejection holes disposed between the lower holding members in top view.

### TECHNICAL FIELD

The present invention relates to a filtration apparatus.

### BACKGROUND ART

As solid-liquid separation treatment apparatuses used in sewage treatment and in processes for producing pharmaceuticals and the like, filtration apparatuses including filtration modules, in which a plurality of hollow-fiber membranes are bundled, have been used.

Such a filtration apparatus is immersed in a liquid to be treated when used, and performs a filtration process by blocking impurities contained in the liquid to be treated at the surfaces of the hollow-fiber membranes and allowing components other than the impurities to permeate into the hollow-fiber membranes.

Japanese Unexamined Patent Application Publication No. 2013-56346 describes an example of a filtration apparatus. This filtration apparatus includes a plurality of filtration modules, each including a plurality of hollow-fiber membranes arranged in parallel in a vertical direction, an upper holding member (water-collecting header) that communicates with upper openings of the hollow-fiber membranes, and a lower holding member (holder) that holds lower portions of the hollow-fiber membranes. The filtration apparatus is configured such that filtrate that has passed through the hollow-fiber membranes of the filtration modules can be extracted through water-collecting pipes that communicate with the upper holding members.

The filtration apparatus also includes a pressurized-gas supply pipe that is disposed below the filtration modules and has a plurality of gas jetting holes. The filtration apparatus is configured such that gas is supplied to the filtration modules through the pressurized-gas supply pipe so that the impurities that have adhered to the surfaces of the hollow-fiber membranes may be removed by the gas.

### CITATION LIST

### Patent Literature

PTL 1: Japanese Unexamined Patent Application Publication No. 2013-56346

### SUMMARY OF INVENTION

### Technical Problem

However, the filtration modules of the filtration apparatus described in the above publication are suspended in the liquid to be treated, and therefore it is difficult to densely arrange the filtration modules. In addition, the filtration apparatus is configured such that the filtration modules and the pressurized-gas supply pipe are separately arranged in an immersion tank. Therefore, the filtration apparatus may be increased in size. In addition, since the filtration apparatus is configured such that the filtration modules are suspended in the liquid to be treated, the filtration modules may swing in response to, for example, flow of the liquid to be treated. As a result, there is a risk that the gas ejected from the pressurized-gas supply pipe cannot be appropriately supplied to the hollow-fiber membranes.

The present invention has been made in light of the above circumstances, and an object of the present invention is to provide a filtration apparatus which can be reduced in size by relatively densely arranging a plurality of filtration modules and in which the efficiency of cleaning the hollow-fiber membranes can be increased.

### Solution to Problem

According to an aspect of the present invention made to solve the problem, a filtration apparatus includes a plurality of filtration modules, each including a plurality of hollow-fiber membranes, which are arranged in parallel in a vertical direction so as to form a substantially curtain-like shape, and a pair of rod-shaped holding members that secure top and bottom ends of the hollow-fiber membranes; one or more cleaning modules that supply bubbles to the filtration modules from below; and a frame that holds the filtration modules and the one or more cleaning modules. The filtration modules are arranged in parallel and with substantially constant intervals therebetween. A plurality of guide rails that engage with the lower holding members of the filtration modules extend between opposing surfaces of a plurality of frame members that are arranged horizontally in parallel.

### Advantageous Effects of Invention

According to the filtration apparatus of the present invention, the size of the filtration apparatus can be reduced and the efficiency of cleaning the hollow-fiber membranes can be increased.

### BRIEF DESCRIPTION OF DRAWINGS

FIG. 1 is a schematic perspective view of a filtration apparatus according to an embodiment of the present invention.

FIG. 2 is a schematic perspective view illustrating a frame and guide rails included in the filtration apparatus illustrated in FIG. 1.

FIG. 3 is a schematic perspective view illustrating a filtration module included in the filtration apparatus illustrated in FIG. 1.

FIG. 4 is a schematic front view of the filtration module illustrated in FIG. 3.

FIG. 5 is a schematic side view of the filtration module illustrated in FIG. 3.

FIG. 6 is a schematic side view illustrating the manner in which the filtration apparatus illustrated in FIG. 1 is used.

FIG. 7 is a schematic perspective view illustrating a frame and guide rails included in a filtration apparatus according to an embodiment different from the embodiment of the filtration apparatus illustrated in FIG. 1.

### DESCRIPTION OF EMBODIMENTS

### Description of Embodiments of the Present Invention

First, embodiments of the present invention will be described.

A filtration apparatus according to an embodiment of the present invention includes a plurality of filtration modules, each including a plurality of hollow-fiber membranes, which are arranged in parallel in a vertical direction so as to form a substantially curtain-like shape, and a pair of rod-shaped holding members that secure top and bottom ends of the hollow-fiber membranes; one or more cleaning modules that supply bubbles to the filtration modules from below; and a frame that holds the filtration modules and the one or more cleaning modules. The filtration modules are arranged in parallel and with substantially constant intervals therebetween. A plurality of guide rails that engage with the lower holding members of the filtration modules extend between opposing surfaces of a plurality of frame members that are arranged horizontally in parallel.

The filtration apparatus is configured such that the plurality of filtration modules and one or more cleaning modules are held by a single frame, and therefore the filtration apparatus can be reduced in size. In addition, the filtration apparatus is configured such that the guide rails, which extend between the opposing surfaces of the frame members that are arranged horizontally in parallel, engage with the lower holding members so that the filtration modules are held by the frame. Therefore, the impurities that have adhered to the surfaces of the hollow-fiber membranes can be easily and reliably removed by bubbles supplied from the one or more cleaning modules. In other words, since the filtration apparatus is configured such that the guide rails that engage with the lower holding members extend between the opposing surfaces of the frame members, the bubbles from the one or more cleaning modules can be easily directly supplied to the filtration modules without being blocked by other components. Therefore, the filtration apparatus can be reduced in size and the efficiency of cleaning the hollow-fiber membranes can be increased.

The one or more cleaning modules preferably have bubble ejection holes disposed between the lower holding members in top view. When the bubble ejection holes of the one or more cleaning modules are disposed between the lower holding members in top view, the bubbles ejected from the bubble ejection holes can be appropriately supplied to the filtration modules from the regions between the lower holding members.

The frame is preferably not present in regions between the lower holding members. When the frame is not present in the regions between the lower holding members, the bubbles ejected from bubble ejection holes can be appropriately supplied to the filtration modules.

A plurality of auxiliary frame members, which are arranged horizontally in parallel, are preferably disposed above a pair of frame members between which the guide rails that engage with the lower holding members extend. When the auxiliary frame members are provided above the guide rails, dropping of the filtration modules, for example, can be prevented. When the auxiliary frame members are provided, the strength of the frame is increased, and the vertical width of the frame members between which the guide rails extend can be reduced. Therefore, the pipe installation and maintenance can be facilitated.

The guide rails are preferably a pair of circular rods that are arranged in parallel, and each lower holding member preferably has a pair of grooves formed in both side surfaces thereof, the pair of circular rods being fitted to the pair of grooves. When the guide rails and the lower holding members have such a structure, the guide rails easily and reliably engage with the lower holding members. In addition, with this structure, the guide rails are not disposed between the one or more cleaning modules and the hollow-fiber membranes, and the bubbles from the one or more cleaning modules can be appropriately supplied to the hollow-fiber membranes.

The hollow-fiber membranes arranged between the pair of holding members are preferably slack. In the case where the hollow-fiber membranes arranged between the pair of holding members are slack, when the hollow-fiber membranes are shook, the gaps between the hollow-fiber membranes can be increased to guide the gas through the gaps, and the cleaning effect can be increased by the vibration of the hollow-fiber membranes. In addition, in the case where the hollow-fiber membranes arranged between the pair of holding members are slack, the lower holding members can be easily and reliably retained by the guide rails.

The filtration modules and the guide rails are preferably detachably attached to the frame in such a state that the guide rails are engaged with the lower holding members of the filtration modules. When the filtration modules and the guide rails are detachably attachable while they are integrated together, assembly and disassembly thereof can be facilitated.

In this specification, the expression “a plurality of hollow-fiber membranes are arranged so as to form a substantially curtain-like shape” means that the presence region in which the hollow-fiber membranes are present in a cross section perpendicular to the direction in which the hollow-fiber membranes are arranged in parallel has a long axis that extends in the longitudinal direction of the pair of holding members. The expression “rod-shaped” means a long and narrow shape, more specifically, a shape in which the length in the longitudinal direction is four times the maximum length in a direction perpendicular to the longitudinal direction or more. The expression “substantially constant intervals” means that the interval variation is within 10%, more preferably, 5%. The expression “a plurality of filtration modules are arranged in parallel” means that an angle between the long sides of the presence regions of the hollow-fiber membranes included in the filtration modules in a cross section perpendicular to the direction in which the hollow-fiber membranes are arranged in parallel is in the range of −5° or more and 5° or less. The expression “the hollow-fiber membranes are slack” means that the hollow-fiber membranes fixed to the pair of holding members are not tightly stretched, more specifically, that when portions of the hollow-fiber membranes between the pair of holding members are defined as effective portions, the length of the effective portions (length in the axial direction of the hollow-fiber membranes) is greater than the gap between the pair of holding members.

### Detailed Description of Embodiments of the Present Invention

Filtration apparatuses according to embodiments of the present invention will be described with reference to the drawings.

### First Embodiment

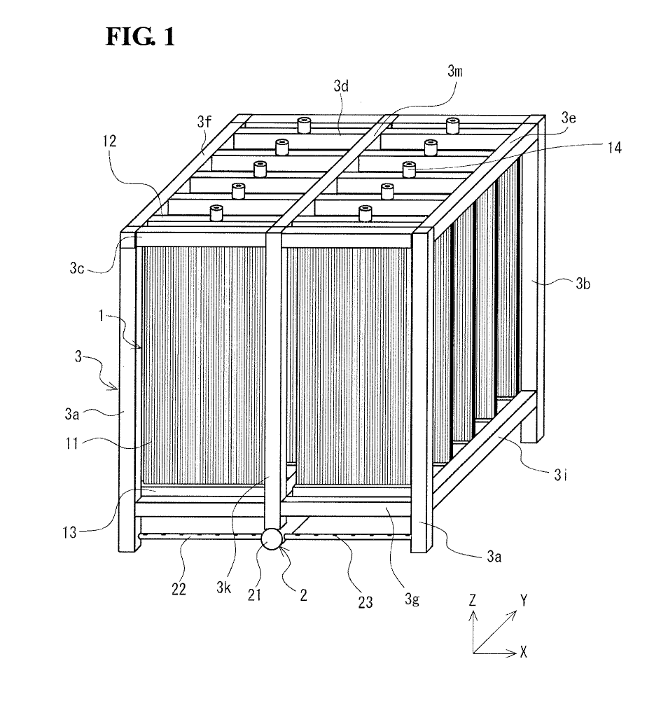

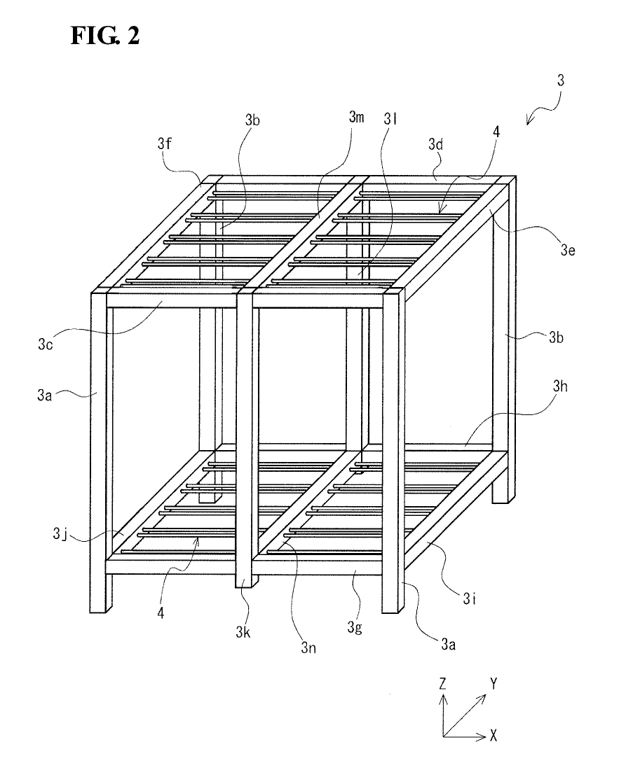

The filtration apparatus illustrated in FIG. 1 is immersed in a liquid to be treated when used. The filtration apparatus performs a filtration process by preventing impurities contained in the liquid to be treated from permeating into hollow-fiber membranes 11 and allowing components other than the impurities to permeate into the hollow-fiber membranes 11. As illustrated in FIGS. 1 and 2, the filtration apparatus mainly includes a plurality of filtration modules 1, a single cleaning module 2, a frame 3 that holds the filtration modules 1 and the cleaning module 2, and a plurality of guide rails 4. The guide rails 4 of the filtration apparatus extend between opposing surfaces of a plurality of frame members of the frame 3 that are arranged horizontally in parallel. In FIG. 1, the guide rails are omitted to improve visibility.

### <Filtration Module>

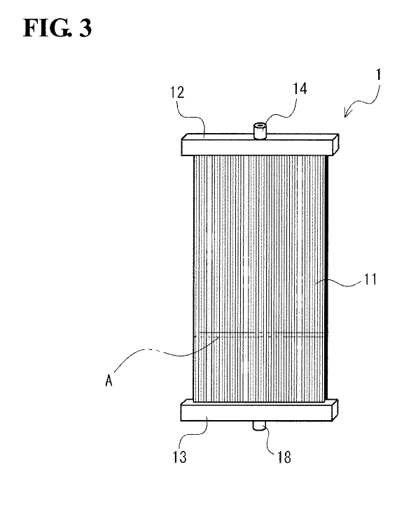

As illustrated in FIG. 3, each filtration module 1 includes the hollow-fiber membranes 11 arranged in parallel in the vertical direction and a pair of rod-shaped holding members (upper holding member 12 and lower holding member 13) that secure the top and bottom ends of the hollow-fiber membranes. Since the top and bottom ends of the hollow-fiber membranes 11 are secured by the rod-shaped upper holding member 12 and lower holding member 13, the hollow-fiber membranes 11 are arranged in parallel in the vertical direction and form a substantially curtain-like shape along the longitudinal direction of the upper holding member 12 and the lower holding member 13. In the following description, the vertical direction in FIG. 1 is defined as the Z direction, the longitudinal direction of the upper holding member 12 and the lower holding member 13 as the X direction, and the horizontal direction perpendicular to the X direction as the Y direction.

The filtration modules 1 are arranged in parallel and with substantially constant intervals therebetween. More specifically, as illustrated in FIGS. 1 and 3, the filtration modules 1 are arranged in two rows so that long sides (sides extending in the X direction) of presence regions A, which are regions in which the hollow-fiber membranes 11 are present in a cross section perpendicular to the direction in which the hollow-fiber membranes 11 are arranged in parallel, are parallel with each other. The presence regions A preferably have a rectangular shape having the long sides and short sizes perpendicular to the long sides. As illustrated in FIG. 1, the filtration modules 1 of each row are arranged with constant intervals therebetween in the short-side direction of the presence regions A (Y direction). Thus, the filtration modules 1 and the spaces between the filtration modules 1 form a striped pattern in top view. The hollow-fiber membranes 11 are preferably arranged in the long-side and short-side directions of the presence regions A in a matrix pattern.

### <Frame>

The frame 3 constitutes a support structure of the filtration apparatus. The frame 3 includes a plurality of frame members. More specifically, as illustrated in FIGS. 1 and 2, the frame members include a pair of front vertical frames 3a and a pair of rear vertical frames 3b that extend in the vertical direction (Z direction) and define four corners of the support structure in top view. The frame members also include a front upper frame 3c, a rear upper frame 3d, a right upper frame 3e, and a left upper frame 3f that extend between the upper portions of the pair of front vertical frames 3a and the pair of rear vertical frames 3b so as to define sides of a rectangle in top view. The frame members also include a front lower frame 3g, a rear lower frame 3h, a right lower frame 3i, and a left lower frame 3j that extend between the lower portions of the pair of front vertical frames 3a and the pair of rear vertical frames 3b so as to define sides of a rectangle in top view.

The frame members also include a front support frame 3k that extends between the centers of the front upper frame 3c and the front lower frame 3g in the axial direction, and a rear support frame 3i that extends between the centers of the rear upper frame 3d and the rear lower frame 3h in the axial direction. In addition, the frame members also include an upper support frame 3m that extends between the centers of the front upper frame 3c and the rear upper frame 3d in the axial direction, and a lower support frame 3n that extends between the centers of the front lower frame 3g and the rear lower frame 3h in the axial direction.

The pair of front and rear upper frames (front upper frame 3c and rear upper frame 3d) of the frame 3 are arranged horizontally in parallel, and the pair of front and rear lower frames (front lower frame 3g and rear lower frame 3h) of the frame 3 are arranged horizontally in parallel. In addition, the pair of right and left upper frames (right upper frame 3e and left upper frame 3f) and the upper support frame 3m of the frame 3 are arranged horizontally in parallel, and the pair of right and left lower frames (right lower frame 3i and left lower frame 3j) and the lower support frame 3n of the frame 3 are arranged horizontally in parallel.

### <Guide Rails>

The guide rails 4 engage with the upper holding members 12 and the lower holding members 13 of the filtration modules 1. As illustrated in FIG. 2, the guide rails 4 extend between the opposing surfaces of the frame members that are arranged horizontally in parallel. More specifically, the guide rails 4 extend between the opposing surfaces of the upper and lower frames forming one side of the support structure of the filtration apparatus (right upper frame 3e and right lower frame 3i) and the pair of upper and lower support frames (upper support frame 3m and lower support frame 3n). In FIG. 2, the guide rails 4 extend between the left side surface of the right upper frame 3e and the right side surface of the upper support frame 3m and between the left side surface of the right lower frame 3i and the right side surface of the lower support frame 3n. Similarly, the guide rails 4 also extend between the opposing surfaces of the upper and lower frames forming the other side of the support structure of the filtration apparatus (left upper frame 3f and left lower frame 3j) and the pair of upper and lower support frames (upper support frame 3m and lower support frame 3n). In FIG. 2, the guide rails 4 extend between the right side surface of the left upper frame 3f and the left side surface of the upper support frame 3m and between the right side surface of the left lower frame 3j and the left side surface of the lower support frame 3n. The guide rails 4 that extend between the opposing surfaces of the upper frames (right upper frame 3e and left upper frame 3f) and the upper support frame 3m and the guide rails 4 that extend between the opposing surfaces of the lower frames (right lower frame 3i and left lower frame 3j) and the lower support frame 3n are disposed at the same positions in top view.

The upper and lower frames forming one side (right upper frame 3e and right lower frame 3i) and the upper and lower frames forming the other side (left upper frame 3f and left lower frame 3j) have holes (not shown) for receiving the guide rails 4 in the opposing surfaces thereof. The upper and lower frames may be attached to the guide rails 4 from the sides by inserting the ends of the guide rails 4 into the holes. The upper and lower frames may be detached from the guide rails 4 by pulling the guide rails 4 out of the holes. The upper and lower frames may be connectable to the pair of front vertical frames 3a and the pair of rear vertical frames 3b with, for example, bolts and nuts so that the upper and lower frames may be securely attached to the guide rails 4.

As illustrated in FIG. 2, the guide rails 4 preferably include pairs of circular rods that are arranged in parallel. The guide rails may instead include pairs of plate-shaped portions that oppose both side surfaces of the lower holding members 13 and projections that project from the plate-shaped portions toward the lower holding members 13.

The filtration apparatus is configured such that the plurality of filtration modules 1 and a single cleaning module 2 are held by a single frame 3, and therefore the filtration apparatus can be reduced in size. In addition, the filtration apparatus is configured such that the guide rails 4, which extend between the opposing surfaces of the frame members that are arranged horizontally in parallel, engage with the lower holding members 13 so that the filtration modules 1 are held by the frame 3. Therefore, the impurities that have adhered to the surfaces of the hollow-fiber membranes can be easily and reliably removed by bubbles supplied from the cleaning module 2. In other words, since the filtration apparatus is configured such that the guide rails 4 that engage with the lower holding members 13 extend between the opposing surfaces of the frame members, the bubbles from the cleaning module 2 can be easily directly supplied to the filtration modules 1 without being blocked by other components. Therefore, the filtration apparatus can be reduced in size and the efficiency of cleaning the hollow-fiber membranes 11 can be increased.

### <Upper Holding Member>

The upper holding member 12 secures the top ends of the hollow-fiber membranes 11. The upper holding member 12 includes a casing with an open bottom into which the top end portions of the hollow-fiber membranes 11 are inserted from below. The upper holding member 12 is configured such that the spaces between the casing and the hollow-fiber membranes 11 and the spaces between the hollow-fiber membranes 11 are filled with a resin composition. More specifically, the upper holding member 12 is formed integrally with the hollow-fiber membranes 11 by inserting a bundle of hollow-fiber membranes 11, which is formed in advance by bonding the top end portions of the hollow-fiber membranes 11 together with the resin composition, into the casing, and filling the spaces between the resin composition and the casing or between the hollow-fiber membranes 11 and the casing with additional resin composition. As illustrated in FIGS. 3 to 5, the upper holding member 12 includes a discharge nozzle 14 that projects upward from the upper portion of the casing. The upper holding member 12 is sealed in regions other than portions that communicate with the hollow-fiber membranes 11 and the opening of the discharge nozzle 14. A water pipe (not shown) is connected to the discharge nozzle 14, and the filtration apparatus is configured such that the filtrate can be extracted through the water pipe.

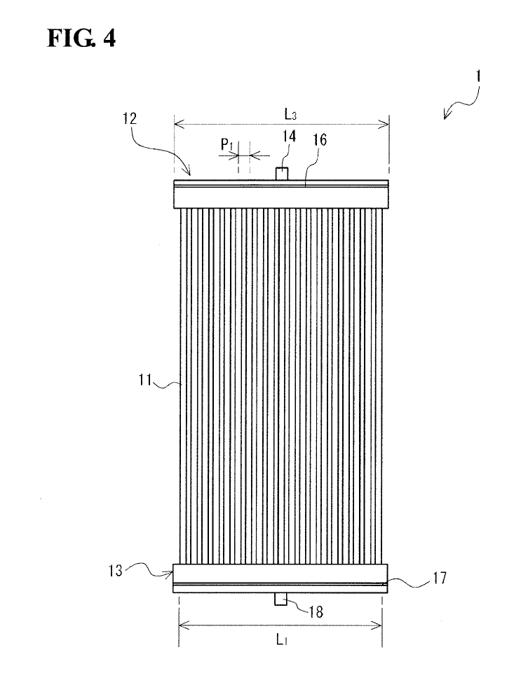

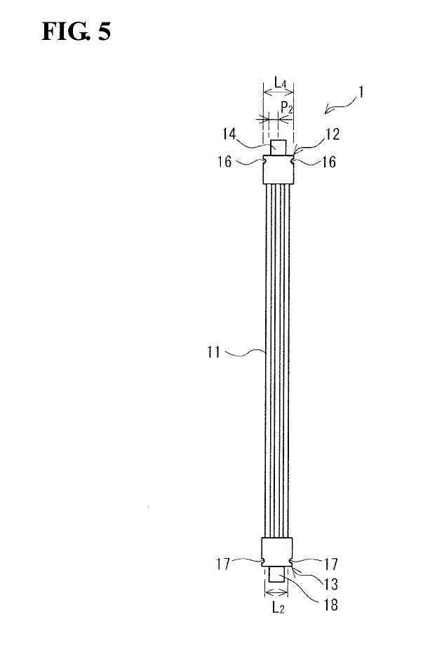

As illustrated in FIGS. 4 and 5, the upper holding member 12 preferably has a pair of grooves 16 engageable with the guide rails 4 in both side surfaces thereof. More specifically, the upper holding member 12 preferably has a pair of grooves 16 that extend in the axial direction at positions that oppose each other in a horizontal direction (X direction in FIG. 1) with a central axis located therebetween. Since the pair of grooves 16 are formed in the upper holding member 12, the filtration apparatus is configured such that the guide rails 4 easily engage with the upper holding member 12. In particular, when the guide rails 4 are a pair of circular rods arranged in parallel and the pair of grooves 16 engageable with the pair of circular rods are formed in both side surfaces of the upper holding member 12, the filtration apparatus is configured such that the guide rails 4 easily and reliably engage with the upper holding member 12.

The lower limit of the length L₃ of the upper holding member 12 in the longitudinal direction (length in the X direction in FIG. 1) is preferably 400 mm, and more preferably, 600 mm. The upper limit of the length L₃ in the longitudinal direction is preferably 1300 mm, and more preferably, 1100 mm. When the length L₃ in the longitudinal direction is below the lower limit, there is a risk that the upper holding member 12 cannot communicate with a sufficient number of hollow-fiber membranes 11 and sufficient filtration efficiency cannot be obtained. When the length L₃ in the longitudinal direction is above the upper limit, the filtration module 1 may be difficult to handle.

The lower limit of the average width L₄ of the upper holding member 12 (length in the horizontal short-side direction, or Y direction in FIG. 1) is 15 mm, and more preferably, 20 mm. The upper limit of the average width L₄ of the upper holding member 12 is preferably 110 mm, and more preferably, 85 mm. When the average width L₄ of the upper holding member 12 is below the lower limit, there is a risk that the upper holding member 12 cannot communicate with a sufficient number of hollow-fiber membranes 11 and sufficient filtration efficiency cannot be obtained. When the average width L₄ of the upper holding member 12 is above the upper limit, there is a risk that the bubbles ejected from diffuser tubes 22 cannot be appropriately supplied to a central portion of the bundle of hollow-fiber membranes 11.

### <Lower Holding Member>

The lower holding member 13 holds the bottom ends of the hollow-fiber membranes 11. Similar to the upper holding member 12, the lower holding member 13 is formed such that the spaces between the casing and the hollow-fiber membranes 11 and the spaces between the hollow-fiber membranes 11 are filled with a resin composition. As illustrated in FIGS. 3 to 5, the lower holding member 13 includes a discharge nozzle 18 that projects downward from the lower portion of the casing. The lower holding member 13 is sealed in regions other than portions that communicate with the hollow-fiber membranes 11 and the opening of the discharge nozzle 18. A water pipe (not shown) is connected to the discharge nozzle 18. The filtration apparatus is configured such that the upper holding member 12 and the lower holding member 13 are connected to the respective water pipes so that the filtrate can be extracted from both the upper holding member 12 and the lower holding member 13.

As illustrated in FIGS. 4 and 5, the lower holding member 13 preferably has a pair of grooves 17 engageable with the guide rails 4 in both side surfaces thereof. More specifically, the lower holding member 13 preferably has a pair of grooves 17 that extend in the axial direction at positions that oppose each other in a horizontal direction (X direction in FIG. 1) with a central axis located therebetween. Since the pair of grooves 17 are formed in the lower holding member 13, the filtration apparatus is configured such that the guide rails 4 easily engage with the lower holding member 13. In particular, when the guide rails 4 are a pair of circular rods arranged in parallel and the pair of grooves 17 engageable with the pair of circular rods are formed in both side surfaces of the lower holding member 13, the filtration apparatus is configured such that the guide rails 4 easily and reliably engage with the lower holding member 13. In addition, with this structure, the guide rails 4 are not disposed between the cleaning module 2 and the hollow-fiber membranes 11, and the bubbles from the cleaning module 2 can be appropriately supplied to the hollow-fiber membranes 11.

The filtration apparatus is preferably configured such that the frame is not present in regions between the lower holding members 13. In particular, the filtration apparatus is preferably configured such that the frame is not present in regions between the lower holding members 13 and such that the frame is also not present in regions between the lower holding members 13 in top view and in a region below the lower holding members 13 in horizontal view. Such a configuration of the filtration apparatus may be obtained by engaging the pairs of upper and lower guide rails 4 (pairs of circular rods), which extend from the upper frames (right upper frame 3e and left upper frame 3f) and the lower frames (right lower frame 3i and left lower frame 3j) to the pair of upper and lower support frames (upper support frame 3m and lower support frame 3n), with the corresponding pairs of grooves. Since the filtration apparatus is configured such that the frame is not present in the regions between the lower holding members 13, the bubbles ejected from bubble ejection holes 23 can be appropriately supplied to the filtration modules from the regions between the lower holding members 13.

The length of each lower holding member 13 in the longitudinal direction (length in the X direction in FIG. 1) may be the same as the length L₃ of each upper holding member 12 in the longitudinal direction. The average width of each lower holding member 13 (length in the Y direction in FIG. 1) may be the same as the average width L₄ of each upper holding member 12.

Each filtration module 1 may include a connecting member for connecting the upper holding member 12 to the lower holding member 13 to facilitate handling (transportation, installation, replacement, etc.) thereof. The connecting member may be, for example, a support rod made of a metal or a casing (external cylinder) made of a resin.

### <Method for Attaching Filtration Modules>

A method for attaching the filtration modules 1 of the filtration apparatus includes, for example, a step of removing the guide rails 4 from the upper and lower frames forming one side (right upper frame 3e and right lower frame 3i) and the upper and lower frames forming the other side (left upper frame 3f and left lower frame 3j); a step of fitting the removed guide rails 4 to the grooves in each filtration module 1; and a step of attaching the upper and lower frames to the guide rails 4 after fitting the guide rails 4 to the grooves in each filtration module 1.

Thus, the filtration apparatus is configured such that the filtration modules 1 and the guide rails 4 are detachable from the frame 3 while the lower guide rails 4 are engaged with the lower holding members 13 of the filtration modules 1. With this structure, the filtration modules 1 can be easily attached as described above. The filtration modules 1 can also be easily detached for maintenance or replacement.

In the case where the cleaning module 2, which will be described below, includes a coarse bubble generator, the coarse bubble generator may be integrated with the filtration modules 1 and the guide rails 4. In such a case, the coarse bubble generator can also be attached to and detached from the frame together with the filtration modules 1 and the guide rails 4.

### <Cleaning Module>

The cleaning module 2 supplies bubbles to the filtration modules 1 from below. As illustrated in FIG. 1, the cleaning module 2 includes a gas supply pipe 21, a gas supplying device (not shown) that supplies gas to the gas supply pipe 21, and the diffuser tubes 22 connected to the gas supply pipe 21.

The gas supply pipe 21 is substantially L-shaped. More specifically, the gas supply pipe 21 includes a vertical portion that extends in the vertical direction (Z direction in FIG. 1) at a location behind the filtration modules 1 and a horizontal portion that extends forward from the bottom end of the vertical portion. The horizontal portion of the supply pipe 21 is connected to the diffuser tubes 22. More specifically, the diffuser tubes 22 are connected to the horizontal portion so as to extend in a direction (X direction in FIG. 1) that is perpendicular to the axial direction of the horizontal portion (Y direction in FIG. 1). The vertical portion of the gas supply pipe 21 is connected to the rear upper frame 3d and the rear lower frame 3h, and the horizontal portion of the gas supply pipe 21 is connected to the lower support frame 3n, so that the gas supply pipe 21 is held by the frame 3.

As illustrated in FIG. 1, the diffuser tubes 22 are disposed below the filtration modules 1. The diffuser tubes 22 have the bubble ejection holes 23 from which bubbles are ejected. The diffuser tubes 22 are arranged in parallel in the width direction of the filtration modules 1 (X direction in FIG. 1).

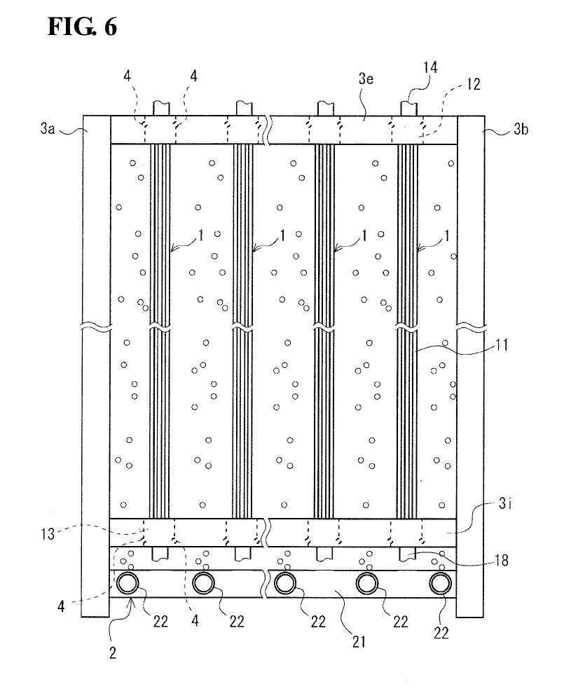

As illustrated in FIG. 6, the diffuser tubes 22 are preferably arranged such that the bubble ejection holes 23 are disposed between the lower holding members 13 in top view. Since the filtration apparatus is configured such that the bubble ejection holes 23 of the cleaning module 2 are disposed between the lower holding members 13 in top view, the bubbles ejected from the bubble ejection holes 23 can be appropriately supplied to the filtration modules 1 from the regions between the lower holding members 13. As illustrated in FIG. 6, the diffuser tubes 22 are preferably arranged such that the bubble ejection holes 23 are disposed between the lower holding members 13 in top view and such that the bubble ejection holes 23 are also disposed in front of the lower holding member 13 at the front end (left end in FIG. 6) of each row and behind the lower holding member 13 at the rear end (right end in FIG. 6) of each row. Since the filtration apparatus is configured such that the bubble ejection holes 23 are disposed in front of the lower holding member 13 at the front end of each row and behind the lower holding member 13 at the rear end of each row, the bubbles can be supplied to each filtration module 1 from the regions on the front and rear sides of the lower holding member 13. As a result, the efficiency of supplying bubbles to the filtration modules 1 of the filtration apparatus can be further increased.

The cleaning module 2 may include coarse bubble generators that are arranged between the diffuser tubes 22 and the filtration modules 1 and that intermittently supply gas ejected from the diffuser tubes 22 to the spaces between the filtration modules 1. The coarse bubble generators may be, for example, devices that store the gas supplied from the diffuser tubes 22 and that intermittently eject the gas when the volume of the gas reaches a predetermined volume.

### <Hollow-Fiber Membranes>

The hollow-fiber membranes 11 are tubes formed of porous films that allow water to permeate therethrough and prevent impurities contained in the liquid to be treated from permeating therethrough.

The lower limit of the average length L₁ of the presence regions A in the long-side direction (X direction in FIG. 1) is preferably 300 mm, and more preferably, 500 mm. The upper limit of the average length L₁ is preferably 1200 mm, and more preferably, 1000 mm. When the average length L₁ is below the lower limit, there is a risk that sufficient filtration efficiency cannot be obtained. When the average length L₁ is above the upper limit, handling may become difficult.

The lower limit of the average length L₂ of the presence regions A in the short-side direction (Y direction in FIG. 1) is preferably 10 mm, and more preferably, 15 mm. The upper limit of the average length L₂ is preferably 100 mm, and more preferably, 75 mm. When the average length L₂ is below the lower limit, there is a risk that sufficient filtration efficiency cannot be obtained. When the average length L₂ is above the upper limit, there is a risk that the bubbles ejected from the diffuser tubes 22, which will be described below, cannot be appropriately supplied to the central portions of the bundles of the hollow-fiber membranes 11.

The lower limit of the ratio of the average length L₂ of the presence regions A in the short-side direction to the average length L₁ of the presence regions A in the longitudinal direction (L₂/L₁) is preferably 1/80, and more preferably, 1/50. The upper limit of the ratio of the average length L₂ to the average length L₁ (L₂/L₁) is preferably 1/3, and more preferably, 1/10. When the ratio of the average length L₂ to the average length L₁ (L₂/L₁) is below the lower limit, the filtration modules 1 may be difficult to handle. When the ratio of the average length L₂ to the average length L₁ (L₂/L₁) is above the upper limit, there is a risk that the bubbles ejected from the diffuser tubes 22 cannot be appropriately supplied to the central portions of the bundles of the hollow-fiber membranes 11.

The lower limit of the average interval between the presence regions A of the filtration modules 1 that are adjacent to each other in the front-rear direction (average interval in the Y direction in FIG. 1) in each row is preferably 10 mm, and more preferably, 15 mm. The upper limit of the average interval between the presence regions A is preferably 30 mm, and more preferably, 25 mm. When the average interval between the presence regions A is below the lower limit, the attachment and detachment of the filtration modules 1 may be difficult. When the average interval between the presence regions A is above the upper limit, there is a risk that the density of the filtration modules 1 will be reduced and the filtration efficiency will be reduced accordingly.

The average pitch P₁ of the hollow-fiber membranes 11 in the long-side direction is preferably greater than the average pitch P₂ of the hollow-fiber membranes 11 in the short-side direction. The lower limit of the ratio of the average pitch P₂ of the hollow-fiber membranes 11 in the short-side direction to the average pitch P₁ of the hollow-fiber membranes 11 in the long-side direction is preferably 2/5, and more preferably, 1/2. The upper limit of the ratio of the average pitch P₂ of the hollow-fiber membranes 11 in the short-side direction to the average pitch P₁ of the hollow-fiber membranes 11 in the long-side direction is preferably 4/5, more preferably, 2/3. When the ratio (P₂/P₁) is below the lower limit, there is a risk that the density of the hollow-fiber membranes 11 in the long-side direction will be reduced and sufficient filtration efficiency cannot be obtained. When the ratio (P₂/P₁) is above the upper limit, there is a risk that sufficient amount of bubbles ejected from the diffuser tubes 22 cannot be supplied to the regions between the hollow-fiber membranes 11.

The lower limit of the filling area ratio of the hollow-fiber membranes 11 in the presence regions A is preferably 20%, more preferably, 30%. The upper limit of the filling area ratio of the hollow-fiber membranes 11 in the presence regions A is preferably 60%, more preferably, 55%. When the filling area ratio of the hollow-fiber membranes 11 is below the lower limit, there is a risk that the number of hollow-fiber membranes 11 per unit area will be reduced and sufficient filtration efficiency cannot be obtained. When the filling area ratio of the hollow-fiber membranes 11 is above the upper limit, there is a risk that the gaps between the hollow-fiber membranes 11 will be excessively small and sufficient amount of bubbles ejected from the diffuser tubes 22 cannot be supplied to the spaces between the hollow-fiber membranes 11.

The lower limit of the number of hollow-fiber membranes 11 arranged in each presence region A in the short-side direction (arrangement number) is preferably 8, more preferably, 12. The upper limit of the number of hollow-fiber membranes 11 arranged in the short-side direction is preferably 50, more preferably, 40. When the number of hollow-fiber membranes 11 arranged in the short-side direction is below the lower limit, there is a risk that sufficient filtration efficiency per unit area cannot be obtained. When the number of hollow-fiber membranes 11 arranged in the short-side direction is above the upper limit, there is a risk that sufficient amount of bubbles ejected from the diffuser tubes 22 cannot be supplied to the spaces between the hollow-fiber membranes 11.

The lower limit of the ratio of the average pitch P₂ in the short-side direction to the average outer diameter of the hollow-fiber membranes 11 is preferably 1. The upper limit of the ratio of the average pitch P₂ in the short-side direction to the average outer diameter of the hollow-fiber membranes 11 is preferably 3/2, more preferably, 7/5. When the ratio of the average pitch P₂ in the short-side direction to the average outer diameter of the hollow-fiber membranes 11 is below the lower limit, the hollow-fiber membranes 11 are arranged in such a state that the hollow-fiber membranes 11 are compressed in the radial direction. Therefore, it may be difficult to manufacture the filtration module 1. When the ratio of the average pitch P₂ in the short-side direction to the average outer diameter of the hollow-fiber membranes 11 is above the upper limit, there is a risk that the density of the hollow-fiber membranes 11 in the short-side direction will be reduced and sufficient filtration efficiency cannot be obtained.

The lower limit of the average outer diameter of the hollow-fiber membranes 11 is preferably 1 mm, more preferably, 1.5 mm, and still more preferably, 2 mm. The upper limit of the average outer diameter of the hollow-fiber membranes 11 is preferably 6 mm, more preferably, 5 mm, and still more preferably, 4 mm. When the average outer diameter of the hollow-fiber membranes 11 is below the lower limit, there is a risk that the mechanical strength of the hollow-fiber membranes 11 will be insufficient. When the average outer diameter of the hollow-fiber membranes 11 is above the upper limit, there is a risk that the flexibility of the hollow-fiber membranes 11 will be insufficient and the hollow-fiber membranes 11 cannot be sufficiently vibrated or shook when the gas comes into contact therewith. As a result, the gaps between the hollow-fiber membranes 11 cannot be increased to guide the gas through the gaps. There is also a risk that the ratio of the surface area of the hollow-fiber membranes 11 to the cross sectional area of the hollow-fiber membranes 11 will be reduced and the filtration efficiency will be reduced accordingly.

The lower limit of the average inner diameter of the hollow-fiber membranes 11 is preferably 0.3 mm, more preferably, 0.5 mm, and still more preferably, 0.9 mm. The upper limit of the average inner diameter of the hollow-fiber membranes 11 is preferably 4 mm, more preferably, 3 mm. When the average inner diameter of the hollow-fiber membranes 11 is below the lower limit, there is a risk that the pressure loss that occurs when the filtrate is discharged from the hollow-fiber membranes 11 will be increased. When the average inner diameter of the hollow-fiber membranes 11 is above the upper limit, there is a risk that the thickness of the hollow-fiber membranes 11 will be reduced and the mechanical strength and impurity blocking effect will be insufficient.

The lower limit of the ratio of the average inner diameter to the average outer diameter of the hollow-fiber membranes 11 is preferably 3/10, more preferably, 2/5. The upper limit of the ratio of the average inner diameter to the average outer diameter of the hollow-fiber membranes 11 is preferably 4/5, more preferably, 3/5. When the ratio of the average inner diameter to the average outer diameter of the hollow-fiber membranes 11 is below the lower limit, there is a risk that the thickness of the hollow-fiber membranes 11 will be excessively increased and the water permeability of the hollow-fiber membranes 11 will be reduced. When the ratio of the average inner diameter to the average outer diameter of the hollow-fiber membranes 11 is above the upper limit, there is a risk that the thickness of the hollow-fiber membranes 11 will be reduced and the mechanical strength and impurity blocking effect will be insufficient.

The lower limit of the average effective length of the hollow-fiber membranes 11 (average length of the effective portions of the hollow-fiber membranes 11) is preferably 1 m, more preferably, 2 m. The upper limit of the average effective length of the hollow-fiber membranes 11 is preferably 6 m, more preferably, 5 m. When the average effective length of the hollow-fiber membranes 11 is below the lower limit, there is a risk that the hollow-fiber membranes 11 cannot be sufficiently shook by the gas that flows along the hollow-fiber membranes 11 and the gaps between the hollow-fiber membranes 11 cannot be increased to guide the gas through the gaps. When the average effective length of the hollow-fiber membranes 11 is above the upper limit, there is a risk that the amount by which the fiber membranes 11 are bent will be excessively increased due to the weight of the hollow-fiber membranes 11, and the filtration modules 1 cannot be easily handled when the filtration modules 1 are attached or detached.

The hollow-fiber membranes 11 arranged between the upper holding members 12 and the lower holding members 13 are preferably slack. In the case where the filtration apparatus is configured such that the hollow-fiber membranes 11 are slack, when the hollow-fiber membranes 11 are shook, the gaps between the hollow-fiber membranes 11 can be increased to guide the gas through the gaps, and the cleaning effect can be increased by the vibration of the hollow-fiber membranes 11. In addition, in the case where the filtration apparatus is configured such that the hollow-fiber membranes 11 are slack, the lower holding members 13 can be easily and reliably retained by the guide rails 4.

When the hollow-fiber membranes 11 are slack, the lower limit of the ratio of the average effective length of the hollow-fiber membranes 11 to the gap between the upper holding members 12 and the lower holding members 13 (average linear distance between both ends of the effective portion of each hollow-fiber membrane 11) in a used state (an easy example is the ratio between the length of an arc and the length of a chord when the effective portions of the hollow-fiber membranes 11 are slack and are arc-shaped) is preferably 1.01, more preferably, 1.02. The upper limit of the ratio is preferably 1.2, more preferably, 1.1. When this ratio is below the lower limit, the hollow-fiber membranes 11 cannot be sufficiently shook by the gas that flows along the hollow-fiber membranes 11, and there is a risk that the gaps between the hollow-fiber membranes 11 cannot be sufficiently increased to guide the gas through the gaps. When this ratio is above the upper limit, there is a risk that the cleaning effect cannot be sufficiently increased, and the filtration modules 1 cannot be easily handled when the filtration modules 1 are attached or detached.

### <Advantages>

The filtration apparatus is configured such that the plurality of filtration modules 1 and a single cleaning module 2 are held by a single frame 3, and therefore the filtration apparatus can be reduced in size. In addition, the filtration apparatus is configured such that the guide rails 4, which extend between the opposing surfaces of the frame members that are arranged horizontally in parallel, engage with the lower holding members 13 so that the filtration modules 1 are held by the frame 3. Therefore, the impurities that have adhered to the surfaces of the hollow-fiber membranes can be easily and reliably removed by bubbles supplied from the cleaning module 2. In other words, since the filtration apparatus is configured such that the guide rails 4 that engage with the lower holding members 13 extend between the opposing surfaces of the frame members, the bubbles from the cleaning module 2 can be easily directly supplied to the filtration modules 1 without being blocked by other components. Therefore, the filtration apparatus can be reduced in size and the efficiency of cleaning the hollow-fiber membranes 11 can be increased.

### Second Embodiment

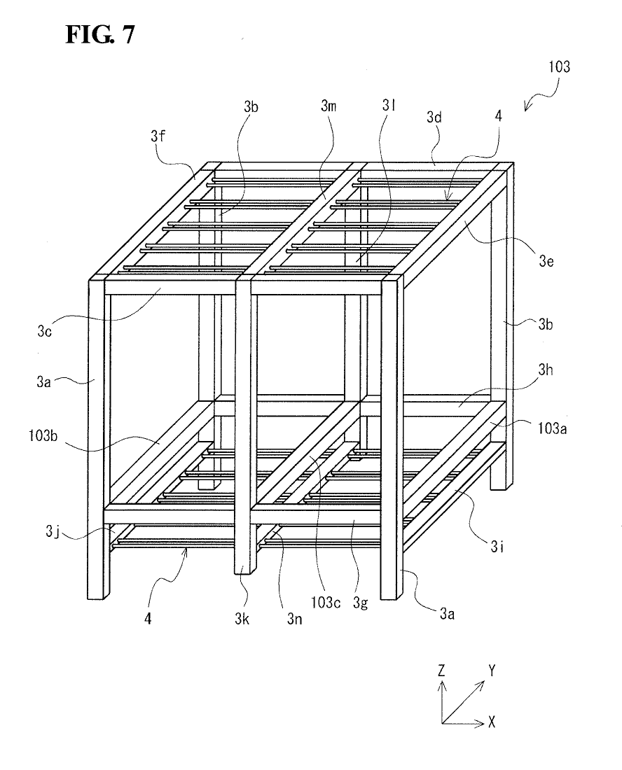

Similar to the filtration apparatus of the first embodiment, a filtration apparatus according to a second embodiment is immersed in a liquid to be treated when used, and mainly includes a plurality of filtration modules, a cleaning module, a frame that holds the filtration modules and the cleaning module, and a plurality of guide rails. As illustrated in FIG. 7, the filtration apparatus is similar to the filtration apparatus according to the first embodiment except that a frame 103 has a different shape.

The filtration apparatus is configured such that the guide rails 4 extend between opposing surfaces of frame members of the frame 103 that are arranged horizontally in parallel. The frame members of the frame 103 other than three auxiliary frame members described below (right auxiliary frame 103a, left auxiliary frame 103b, and central auxiliary frame 103c) are similar to those of the frame 3 illustrated in FIG. 2 except that, for example, some frame members described below have a different width in the vertical direction. Therefore, the frame members other than the auxiliary frame members are denoted by the same reference numerals as those of the frame 3, and descriptions thereof are omitted.

The auxiliary frame members are arranged horizontally in parallel above the frame members between which the guide rails 4 that engage with lower holding members extend (right lower frame 3i, left lower frame 3j, and lower support frame 3n, which are hereinafter referred to as lower-guide-rail retaining frame members). The auxiliary frame members prevent vibration and dropping of the filtration modules.

The width of the auxiliary frame members in the vertical direction is preferably greater than the width of the lower-guide-rail retaining frame members in the vertical direction. When the vertical width of the auxiliary frame members is greater than that of the lower-guide-rail retaining frame members, the vertical width of the lower-guide-rail retaining frame members can be reduced while maintaining the strength of the frame 103. As a result, since the vertical width of the lower-guide-rail retaining frame members can be reduced, pipes such as the water-collecting pipes can be more easily installed and maintenance of the lower portions of the filtration modules can be facilitated.

As illustrated in FIG. 7, a front lower frame 3g, which extends between the lower portions of a pair of front vertical frames 3a, and a rear lower frame 3h, which extends between the lower portions of a pair of rear vertical frames 3b, are preferably disposed at the same height as the auxiliary frame members. When the lower frames other than the lower frames between which the guide rails 4 that engage with the lower holding members extend are at the same height as the auxiliary frame members, the strength and designability of the frame 103 can be increased. However, the lower frames other than the lower frames between which the guide rails 4 extend (front lower frame 3g and rear lower frame 3h) may instead be disposed at the same height as the lower frames between which the guide rails 4 extend (right lower frame 3i, left lower frame 3j, and lower support frame 3n).

The central auxiliary frame 103c may be omitted as long as the filtration apparatus includes the auxiliary frame members at least at the outer sides of the frame 103 (between the front vertical frames 3a and rear vertical frames 3b).

When the filtration modules are to be attached or detached, the right auxiliary frame 103a or the left auxiliary frame 103b may be removed from the other frames. Thus, the filtration modules can be easily attached or detached.

### Other Embodiments

It is to be understood that the above disclosed embodiments are examples and are not restrictive in all respects. The scope of the present invention is not limited by the configurations of the above-described embodiments, and is defined by the claims. The present invention is intended to include equivalents to the scope of the claims and all modifications within the scope of the claims.

For example, the filtration modules of the filtration apparatus are not necessarily arranged in two rows, and may instead be arranged in, for example, a single row. The filtration apparatus is not limited to those including a single cleaning module, and may instead include a plurality of cleaning modules including gas supplying devices and diffuser tubes connected to the gas supplying devices.

The filtration apparatus is not necessarily configured such that the discharge nozzles are formed on both the upper holding members and the lower holding members. More specifically, the filtration apparatus may be configured such that the discharge nozzles are formed on either the upper holding members or the lower holding members, and such that the filtrate is extracted only from the holding members on which the discharge nozzles are formed. The structure of the holding members on which the discharge nozzles are not formed is not particularly limited. For example, the hollow-fiber membranes may be held such that the openings thereof are sealed. Alternatively, each hollow-fiber membrane may be bent in a U-shape, and a bending rod member may be arranged at the bent portion.

The discharge nozzles do not necessarily project from the upper portions of the casings of the upper holding members or the bottom portions of the casings of the lower holding members, and may instead project, for example, from side walls of the upper holding members or the lower holding members in the axial direction so as to extend in the axial direction.

The bubble ejection holes of the cleaning module are not necessarily arranged between the lower holding members in top view, and may instead be arranged in regions that overlap the lower holding members in top view. The filtration apparatus is configured such that, even when the bubble ejection holes of the cleaning module are arranged in regions that overlap the lower holding members in top view, the bubbles can be easily supplied to the filtration modules from the regions between the lower holding members.

The cleaning module may include a guide mechanism that guides the bubbles ejected from the bubble ejection holes of the diffuser tubes to the regions between the lower holding members in top view. An example of such a guide mechanism accumulates the bubbles ejected from the diffuser tubes and intermittently ejects the gas when the volume of the accumulated gas reaches a predetermined volume.

The filtration apparatus may include, for example, a jet-type air-diffusing device in which gas is jetted from a diffuser or sparger, or a bubbling jet nozzle that jets a mixture of water and bubbles as the cleaning module.

The filtration apparatus is preferably configured such that the frame is not present between the lower holding members. However, for example, the frame may be present between some of the lower holding members.

Each lower holding member is not necessarily provided with a pair of grooves that engage with the guide rails, and may instead be formed such that the length (width) thereof between both side surfaces changes stepwise toward the bottom so that the lower holding member is engageable with the guide rails.

The guide rails do not necessarily extend between the upper frames (right upper frame 3e and left upper frame 3f) and the upper support frame 3m as illustrated in FIG. 2. The manner in which the upper holding members are attached is not limited. The upper holding members may be held by, for example, frames that extend in the longitudinal direction of the upper holding members.

The filtration apparatus may include one or more covers that cover the membrane modules to increase the efficiency of cleaning the hollow-fiber membranes.

The filtration apparatus may be used as various types of filtration apparatuses including external pressure-type filtration apparatuses in which the pressure is increased on the outer peripheral surface side of hollow-fiber membranes, and a liquid to be treated is permeated toward the inner peripheral surface side of the hollow-fiber membranes; immersion-type filtration apparatuses in which a liquid to be treated is permeated toward the inner peripheral surface side by means of osmotic pressure or negative pressure on the inner peripheral surface side; and internal pressure-type filtration apparatuses in which the pressure is increased on the inner peripheral surface side of hollow-fiber membranes, and a liquid to be treated is permeated toward the outer peripheral surface side of the hollow-fiber membranes. In particular, the filtration apparatus is suitable for use as an external pressure-type filtration apparatus.

### INDUSTRIAL APPLICABILITY

As described above, the filtration apparatus according to the present invention can be reduced in size by relatively densely arranging the filtration modules, and the efficiency of cleaning the hollow-fiber membranes can be increased. The filtration apparatus is suitable for use as a solid-liquid separation treatment apparatus in various fields.

### REFERENCE SIGNS LIST

1 filtration module

2 cleaning module

3, 103 frame

3a front vertical frame

3b rear vertical frame

3c front upper frame

3d rear upper frame

3e right upper frame

3f left upper frame

3g front lower frame

3h rear lower frame

3i right lower frame

3j left lower frame

3k front support frame

3i rear support frame

3m upper support frame

3n lower support frame

4 guide rail

11 hollow-fiber membrane

12 upper holding member

13 lower holding member

14, 18 discharge nozzle

16 groove

17 groove

21 gas supply pipe

22 diffuser tube

23 bubble ejection hole

103a right auxiliary frame

103b left auxiliary frame

103c central auxiliary frame

1. A filtration apparatus comprising:
a plurality of filtration modules, each including a plurality of hollow-fiber membranes, which are arranged in parallel in a vertical direction so as to form a substantially curtain-like shape, and a pair of rod-shaped holding members that secure top and bottom ends of the hollow-fiber membranes;
one or more cleaning modules that supply bubbles to the filtration modules from below; and
a frame that holds the filtration modules and the one or more cleaning modules,
wherein the filtration modules are arranged in parallel and with substantially constant intervals therebetween, and
wherein a plurality of guide rails that engage with the lower holding members of the filtration modules extend between opposing surfaces of a plurality of frame members that are arranged horizontally in parallel.

2. The filtration apparatus according to claim 1, wherein the one or more cleaning modules have bubble ejection holes disposed between the lower holding members in top view.

3. The filtration apparatus according to claim 1, wherein the frame is not present in regions between the lower holding members.

4. The filtration apparatus according to claim 1, wherein a plurality of auxiliary frame members, which are arranged horizontally in parallel, are disposed above a pair of frame members between which the guide rails that engage with the lower holding members extend.

5. The filtration apparatus according to claim 1, wherein the guide rails are a pair of circular rods that are arranged in parallel, and
wherein each lower holding member has a pair of grooves formed in both side surfaces thereof, the pair of circular rods being fitted to the pair of grooves.

6. The filtration apparatus according to claim 1, wherein the hollow-fiber membranes arranged between the pair of holding members are slack.

7. The filtration apparatus according to claim 1, wherein the filtration modules and the guide rails are detachably attached to the frame in such a state that the guide rails are engaged with the lower holding members of the filtration modules.
